(19) United States
(12) Patent Application Publication
(10) Pub. No.: US 2022/0134901 A1
(43) Pub. Date: May 5, 2022

(54) ELECTRIC VEHICLE CHARGING ENERGY MANAGEMENT SYSTEMS AND METHODS COMBINING MULTIPLE POWER CONSUMPTION AREAS

(71) Applicant: Noodoe Corporation, Taipei City (TW)

(72) Inventor: John C. Wang, Taipei City (TW)

(21) Appl. No.: 17/412,320

(22) Filed: Aug. 26, 2021

(30) Foreign Application Priority Data
Oct. 30, 2020 (TW) 109137779

(51) Int. Cl. B60L 53/63; B60L 53/68; B60L 53/62

(52) U.S. Cl. CPC B60L 53/63; B60L 53/62; B60L 53/68

(57) ABSTRACT

Electric vehicle charging energy management systems and methods combining multiple power consumption areas applied to application field having first power consumption area and second power consumption area and having predetermined power consumption limit are provided. First, power consumption situation of at least one electrical equipment in first power consumption area is detected by power consumption detection device, and power consumption situation corresponding to first power consumption area is received from power consumption detection device by cloud management server via network. Thereafter, available electrical energy is calculated according to predetermined power consumption limit for application field and power consumption situation, and charging efficiency of each of a plurality of electric vehicle charging equipment in second power consumption area is determined according to available electrical energy. Respective charging efficiency is then transmitted to each electric vehicle charging equipment in second power consumption area via network.

### BACKGROUND OF THE INVENTION

### Field of the Invention

The disclosure relates generally to energy management systems and methods thereof, and, more particularly to electric vehicle charging energy management systems and methods that can perform related managements for application fields combining multiple power consumption areas.

### Description of the Related Art

Recently, with the rising awareness of environmental protection and electric vehicle technology advances, the development of electric vehicles powered by electrical energy to replace traditional vehicles powered by fossil fuels has gradually become an important goal in the automotive field, thus making electric vehicles become more and more popular. In order to increase the range and willingness to use electric vehicles, many countries or cities have begun to set up charging stations in public places to provide electricity to electric vehicles, and have also begun to plan the deployment of a large number of charging stations in urban areas or scenic areas, so as to make the charging of electric vehicles more convenient.

With the increasing popularity of electric vehicles, more and more application fields such as communities, factories or office buildings have also begun to set up many charging equipment to provide electric vehicle charging services. However, these areas usually have a preset power consumption upper limit. When multiple charging devices use electricity together with other electrical equipment, the electricity used by the charging equipment to charge the electric vehicle will be accumulated together with the electricity consumption of other electrical equipment. If there is no effective power configuration, it is likely that the total power consumption will exceed the upper limit of power consumption and cause the pressure of power tripping. In addition, due to the pressure of power tripping, only part of the charging equipment may be used at the same time, which limits the use of charging equipment. On the other hand, although it can be considered to increase the power supply equipment to increase the upper limit of power consumption, the price of power supply equipment is expensive, thereby greatly increasing the use cost.

### BRIEF SUMMARY OF THE INVENTION

Electric vehicle charging energy management systems and methods combining multiple power consumption areas are provided, which can detect the power consumption situation of all electrical equipment in the plurality of power consumption areas in the application field in real time, determine the available electrical energy based on the power consumption situation and the predetermined power consumption limit, and dynamically adjust the charging efficiency of each electric vehicle charging equipment according to the available electrical energy to perform the management of electric vehicle charging energy load, so as to effectively configure the power and reduce the pressure of power tripping, thereby providing users with a better experience and improving the practicability of charging services, thus reducing the cost of using electric vehicles and increasing the willingness to use the electric vehicles.

An embodiment of an electric vehicle charging energy management system combining multiple power consumption areas applied to an application field having a predetermined power consumption limit comprises a first power consumption area, a second power consumption area, and a cloud management server. The first power consumption area comprises at least one electrical equipment and a power consumption detection device. The power consumption detection device detects the power consumption situation of at least one electrical equipment in the first power consumption area and transmits the power consumption situation to a network. The second power consumption area comprises a plurality of electric vehicle charging equipment for charging electric vehicles, wherein each electric vehicle charging equipment has a network connection unit, such that each electric vehicle charging equipment has a network connection capability. The cloud management server receives the power consumption situation corresponding to the first power consumption area from the power consumption detection device via a network, calculates an available electrical energy according to the predetermined power consumption limit for the application field and the power consumption situation, and determines a charging efficiency of each of the electric vehicle charging equipment in the second power consumption area according to the available electrical energy. The cloud management server transmits respective charging efficiency to each electric vehicle charging equipment in the second power consumption area via the network, wherein each electric vehicle charging equipment charges at least one electric vehicle according to the respective charging efficiency received from the cloud management server.

In an embodiment of an electric vehicle charging energy management method combining multiple power consumption areas applied to an application field having a first power consumption area and a second power consumption area and having a predetermined power consumption limit, the power consumption situation of at least one electrical equipment in the first power consumption area is detected by a power consumption detection device, and the power consumption situation corresponding to the first power consumption area is received from the power consumption detection device by a cloud management server via a network. Thereafter, an available electrical energy is calculated according to the predetermined power consumption limit for the application field and the power consumption situation, and the charging efficiency of each of a plurality of electric vehicle charging equipment in the second power consumption area is determined according to the available electrical energy. Respective charging efficiency is then transmitted to each electric vehicle charging equipment in the second power consumption area via the network, wherein each electric vehicle charging equipment charges at least one electric vehicle according to the respective charging efficiency received from the cloud management server.

In some embodiments, the cloud management server further determines whether each of the electric vehicle charging equipment is connected to the at least one electric vehicle, and calculates the charging efficiency of each of the electric vehicle charging equipment based on the available electrical energy and the number of electric vehicle charging equipment that have been connected to the at least one electric vehicle.

In some embodiments, when the cloud management server detects that the number of electric vehicle charging equipment that have been connected to the at least one electric vehicle has changed to a new number, the cloud management server further recalculates the charging efficiency of each electric vehicle charging equipment according to the available electrical energy and the new number of electric vehicle charging equipment that have been connected to the at least one electric vehicle.

In some embodiments, the cloud management server further obtains a charging time of each electric vehicle charging equipment for the connected at least one electric vehicle, and calculates an independent charging efficiency of each electric vehicle charging equipment according to the available electrical energy and the charging time of each electric vehicle charging equipment for the connected at least one electric vehicle, wherein each of the electric vehicle charging equipment charges the connected electric vehicle according to the respective independent charging efficiency.

In some embodiments, the cloud management server further obtains a remaining power of the at least one electric vehicle connected to each electric vehicle charging equipment, and calculates an independent charging efficiency of each electric vehicle charging equipment according to the available electrical energy and the remaining power of the at least one electric vehicle connected to each electric vehicle charging equipment, wherein each of the electric vehicle charging equipment charges the connected electric vehicle according to the respective independent charging efficiency.

In some embodiments, the remaining power of the at least one electric vehicle connected to each electric vehicle charging equipment is transmitted to each electric vehicle charging equipment through the at least one electric vehicle, and transmitted to the cloud management server through each electric vehicle charging equipment.

In some embodiments, the remaining power of the at least one electric vehicle connected to each electric vehicle charging equipment is directly transmitted to the cloud management server through the at least one electric vehicle. the cloud management server transmits a charging status of the at least one electric vehicle to a smart phone via a network, and the owner of the at least one electric vehicle uses the smart phone to activate a corresponding charging operation.

In some embodiments, the cloud management server further transmits a specific information to the smart phone via the network when each of the electric vehicle charging equipment stops outputting power to the at least one electric vehicle, wherein the specific information is used to notify the owner that the electric vehicle has stopped charging.

Electric vehicle charging energy management methods combining multiple power consumption areas may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of an electric vehicle charging energy management system combining multiple power consumption areas of the invention;

FIG. 2 is a schematic diagram illustrating an embodiment of an electric vehicle charging equipment of the invention;

FIG. 3 is a schematic diagram illustrating an embodiment of a cloud management server of the invention;

FIG. 4 is a flowchart of an embodiment of an electric vehicle charging energy management method combining multiple power consumption areas of the invention;

FIG. 5 is a flowchart of an embodiment of a method for determining the charging efficiency of the electric vehicle charging equipment of the invention;

FIG. 6 is a flowchart of another embodiment of the method for determining the charging efficiency of the electric vehicle charging equipment of the invention; and

FIG. 7 is a flowchart of another embodiment of the method for determining the charging efficiency of the electric vehicle charging equipment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. It should be understood that the embodiments may be realized in software, hardware, firmware, or any combination thereof.

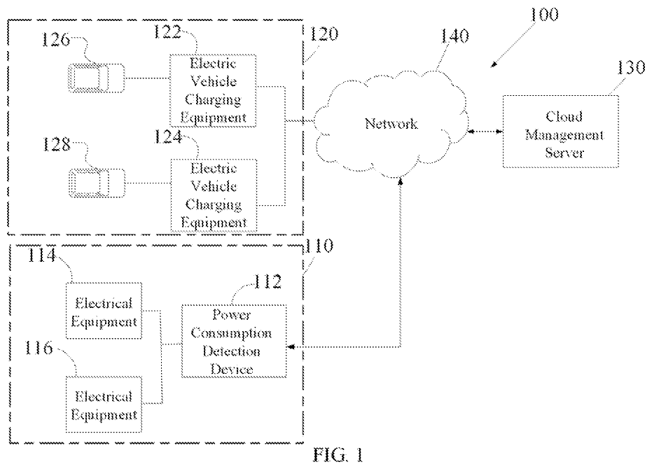

FIG. 1 is a schematic diagram illustrating an embodiment of an electric vehicle charging energy management system combining multiple power consumption areas of the invention. As shown in FIG. 1, the electric vehicle charging energy management system 100 combining multiple power consumption areas of the invention comprises at least one application field with a first power consumption area 110 and a second power consumption area 120 and one cloud management server 130, wherein the first power consumption area 110 comprises at least one power consumption detection device 112 and a plurality of electrical equipment 114 and 116, and the second power consumption area 120 at least comprises a plurality of electric vehicle charging equipment 122 and 124, and the cloud management server 130 can be remotely connected with the electric vehicle charging equipment 122 and 124 and the power consumption detection device 112 through a network 140. The application field has a predetermined power consumption limit, wherein a total power consumption of electrical equipment 114 and 116 in the first power consumption area 110 and the electric vehicle charging equipment 122 and 124 in the second power consumption area 120 shall not exceed the predetermined power consumption limit. It should be noted that when the total power consumption of the electrical equipment 114 and 116 in the first power consumption area 110 and the electric vehicle charging equipment 122 and 124 in the second power consumption area 120 exceeds the predetermined power consumption limit, power tripping will be caused. The power consumption detection device 112 is coupled to the electrical equipment 114 and 116 to detect the electrical equipment 114 and 116 and obtain the power consumption situation of the electrical equipment 114 and 116. In some embodiments, the power consumption detection device 112 may have a detection circuit or other software and hardware components for power consumption detection to detect the power consumption of a specific electrical equipment and generate a power consumption detection data including its power consumption. For example, when the electric vehicle is connected to the charging device 110, the battery detection unit 113 can detect the power level of the battery module of the electric vehicle, so as to obtain the power status corresponding to the battery module from the electric vehicle, and generate the generate power detection data including the power status of the battery module. For example, the power consumption detection device 112 may detect current power consumption of the electrical equipment 114 and 116 respectively, so as to obtain the power consumption situation corresponding to the electrical equipment 114 and 116, and generate the power consumption data including the power consumption situation of the electrical equipment 114 and 116.

In some embodiments, the network 140 may be a wired network, a telecommunication network, and a wireless network, such as a Wi-Fi network or the like. The cloud management server 130 may receive various data from the electrical equipment 114 and 116 and the electric vehicle charging equipment 122 and 124 via the network 140. For example, when the electric vehicle 126 is connected to the electric vehicle charging equipment 122 through a charging gun of the electric vehicle charging equipment 122 to perform a charging operation, the electric vehicle charging equipment 122 can continuously transmit information of charging state corresponding to the charging operation of the electric vehicle 126 to the cloud management server 130 via the network 140, and the cloud management server 130 can receive the charging information of the corresponding charging operation from the electric vehicle charging equipment 122 through the network 140. Similarly, when the electric vehicle 128 is connected to the electric vehicle charging equipment 124 through a charging gun of the electric vehicle charging equipment 124 to perform a charging operation, the electric vehicle charging equipment 124 can continuously transmit information of charging state corresponding to the charging operation of the electric vehicle 128 to the cloud management server 130 via the network 140, and the cloud management server 130 can receive the charging information of the corresponding charging operation from the electric vehicle charging equipment 128 through the network 140. A user of the electric vehicle 126 may connect the electric vehicle 126 with the electric vehicle charging equipment 122 to send a charging request corresponding to the electric vehicle charging equipment 122 to perform a charging operation on the electric vehicle 126 using the electric vehicle charging equipment 122. Similarly, a user of the electric vehicle 128 may connect the electric vehicle 128 with the electric vehicle charging equipment 124 to send a charging request corresponding to the electric vehicle charging equipment 124 to perform a charging operation on the electric vehicle 128 using the electric vehicle charging equipment 124. In some embodiments, the cloud management server 130 may directly or indirectly receive a charging request from a user device (not shown in FIG. 1) of the user of the electric vehicle 126, and after completing payment confirmation and other actions based on the charging request, the cloud management server 130 generates a charging authorization instruction and transmits it to the electric vehicle charging equipment 122 via the network 140. Accordingly, the cloud management server 130 allows the electric vehicle charging equipment 122 to output power to the electric vehicle 126, such as an electric scooter or an electric car, which is electrically connected to it or prohibits the electric vehicle charging equipment 122 from outputting power to the electric vehicle 126. In some embodiments, the user of the electric vehicle 126 can use the user device to download and install an application from the cloud management server 130 via the network 140, and generate the charging request via the user interface of the application. In some embodiments, the user can scan a Quick Response Code (QR code) on the electric vehicle charging equipment 122 by the scanning function of the application to generate the charging request, thereby activating a charging process. For example, in one embodiment, the electric vehicle charging equipment 122 may be an electric vehicle charging station, which may have a single or a plurality of charging guns, and power can be output through the charging gun to charge the electric vehicle 126 when the electric vehicle 126 is coupled to the electric vehicle charging equipment 122 to perform a charging operation through the charging gun of the electric vehicle charging equipment 122. In an embodiment, the electric vehicle charging equipment 122 may provide one electric vehicle for charging at a time. In another embodiment, the electric vehicle charging equipment 122 can provide multiple electric vehicles for charging at the same time. In some embodiments, the electric vehicle charging equipment 122 and 124 may be home chargers. The user device can be any electronic device with Internet access and positioning capabilities, such as mobile phones, smart phones, personal digital assistants, global positioning systems, notebook computers, and in-vehicle devices. In some embodiments, the user of the electric vehicle can use the user device to download and install an application from the cloud management server 130 via the network 140, and generate the charging request via the user interface of the application. In some embodiments, the user device can receive the charging state and notifications corresponding to the charging operation from the cloud management server 130 through the network 140. The notifications may be messages of notifying that the electric vehicle has stopped charging, notifying the moving, and notifying the charging gun of the electric vehicle charging station has been unplugged from the electric vehicle and so on. The cloud management server 130 may generate an instruction and send it to the electric vehicle charging equipment 122 via the network 140 to schedule and control operations of the electric vehicle charging equipment 122 to output power to the electric vehicle 126 that is electrically connected to it or prohibit the electric vehicle charging equipment 122 from outputting electric power to the electric vehicle 126 at a specified charging efficiency in a specific time period. Similarly, the cloud management server 130 may generate an instruction and send it to the electric vehicle charging equipment 124 via the network 140 to schedule and control operations of the electric vehicle charging equipment 124 to output power to the electric vehicle 128 that is electrically connected to it or prohibit the electric vehicle charging equipment 124 from outputting electric power to the electric vehicle 128 at a specified charging efficiency in a specific time period.

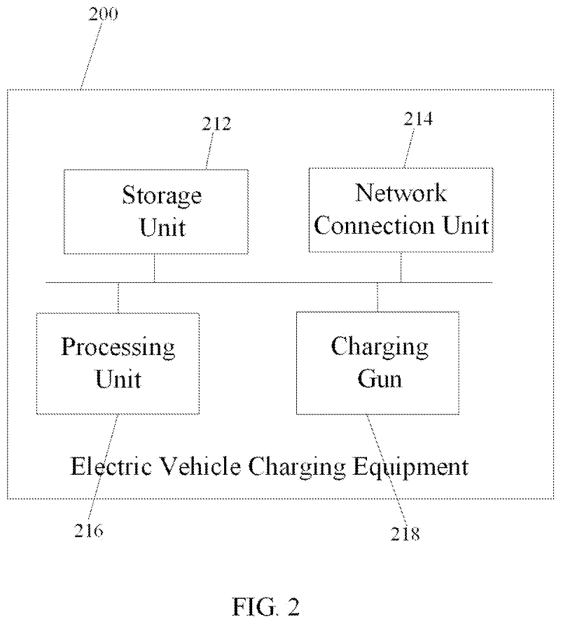

FIG. 2 is a schematic diagram illustrating an embodiment of an electric vehicle charging equipment of the invention. As shown in FIG. 2, the electric vehicle charging equipment 200 can be applied to the electric vehicle charging equipment 122 and 124 and has processing and computing capabilities to perform charging management operations for the electric vehicle charging equipment. The electric vehicle charging equipment 200 also has a network connection capability to receive, download or update various parameters and information required for charging management calculations.

The electric vehicle charging equipment 200 at least comprises a storage unit 212, a network connection unit 214, a processing unit 216, and a charging gun 218. The storage unit 212 may be a memory or a database for storing and recording related data, such as related information of the electric vehicle charging equipment and charging requests information included in the electric vehicle charging equipment. It should be noted that the aforementioned information is only example, and the invention is not limited thereto. The network connection unit 214 may receive, download, or update various parameters and information required for charging management operations via a network, such as a wired network, a telecommunications network, and a wireless network, such as a Wi-Fi network and so on. The processing unit 216 can control related operations of software and hardware in the electric vehicle charging equipment 200, and perform the electric vehicle charging energy management method combining multiple power consumption areas of the invention, which will be discussed later. For example, the processing unit 216 may be a general-purpose controller, a microcontroller (Micro-Control Unit, MCU), or a digital signal controller (Digital Signal Processor, DSP), etc., to provide data analysis, processing, and calculation operations. However, it is understood that the present invention is not limited thereto. In one embodiment, the processing unit 216 may use the network connection unit 214 to transmit the power status of the corresponding electric vehicle via a network for a cloud management server, such as the cloud management server 130, to perform subsequent charging schedules. In another embodiment, the processing unit 216 may obtain the corresponding charging efficiency through the cloud management server 130, and charge at least one electric vehicle according to the charging efficiency. The charging gun 218 may include one or more charging connectors that have the same charging interface specification or have different charging interface specifications. The charging gun 218 is electrically connected to the electric vehicle, and outputs power to the electric vehicle at a specified charging efficiency according to the instruction received from the processing unit 216.

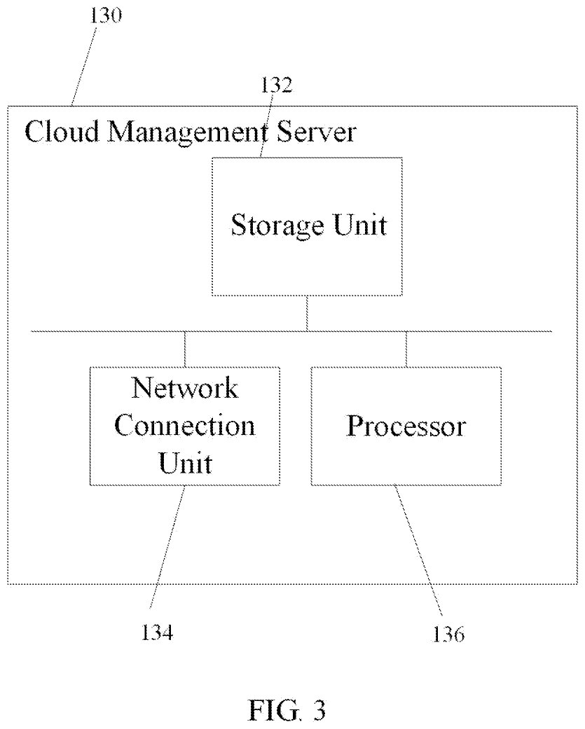

FIG. 3 is a schematic diagram illustrating an embodiment of a cloud management server of the invention. As shown in FIG. 3, the cloud management server 130 of the invention can be any processor-based electronic device, which comprises at least a storage unit 132, a network connection unit 134, and a processor 136. It is noted that the cloud management server 130 can receive various data corresponding to a plurality of electric vehicle charging equipment. The cloud management server 130 may directly or indirectly receive a charging request from a user device, and after completing payment confirmation and other actions in response to the charging request, it generates a charging authorization instruction and transmits it to the corresponding electric vehicle charging equipment via the network, so as to allow the electric vehicle charging equipment to output power to an electric vehicle, such as an electric scooter or an electric car, which is electrically connected to the electric vehicle charging equipment, or prohibit the electric vehicle charging equipment from outputting power to the electric vehicle. In some embodiments, the electric vehicle charging equipment corresponding to the cloud management server 130 can be an electric vehicle charger, which may have a single charging gun or multiple charging guns, and can output power to the electric vehicle through the charging gun (s) for charging.

The storage unit 132 (for example, a memory) may store and record related data, such as power consumption data of the electrical equipment 114 and 116, various data of the electric vehicle charging equipment 122 and 124, and so on. With the network connection unit 134, the cloud management server 130 can be coupled to and communicate with the electric vehicle charging equipment 122 and 124 through the network 140. The network connection unit 134 can couple to the electric vehicle charging stations 110 through a network, such as a wired network, a telecommunication network, and a wireless network, such as a Wi-Fi network, and can transmit related data to different electric vehicle charging equipment via the network, thus to control each electric vehicle charging equipment to or not to output power to charge an electric vehicle. The processor 136 can control the related operations of software and hardware in the cloud management server 130, and perform the electric vehicle charging energy management method combining multiple power consumption areas of the invention, which will be discussed later. For example, the processor 136 may be a general-purpose controller, a microcontroller (Micro-Control Unit, MCU), or a digital signal controller (Digital Signal Processor, DSP), etc., to provide data analysis, processing, and calculation functions. However, it is understood that the present invention is not limited thereto.

The cloud management server 130 may generate instructions and send the instructions to the electric vehicle charging equipment 122 and 124 via the network 140 to schedule and control operations of the electric vehicle charging equipment 122 and 124 to output power to an electric vehicle that is electrically connected to it or prohibit the electric vehicle charging equipment 122 and 124 from outputting electric power to the electric vehicle at a specified charging efficiency in a specific time period.

It should be understood that each of the elements, units or modules in the present embodiments may be a device having a corresponding function, which can have the appropriate hardware circuits or elements to perform the corresponding function, however, the device is not limited to be entity device, which can also be a virtual device having program and software with respective functions or a device having capabilities for processing and running the program and software. The manner of operations of the respective elements can further refer to the following description of the methods.

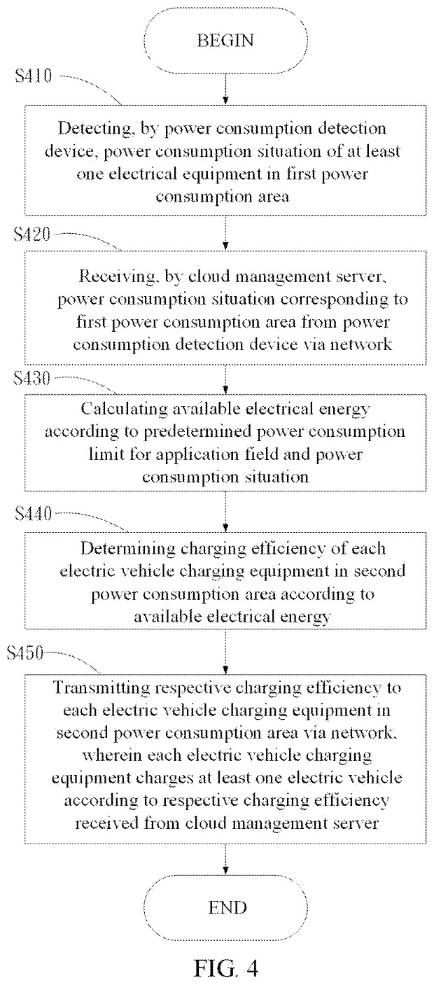

FIG. 4 is a flowchart of an embodiment of an electric vehicle charging energy management method combining multiple power consumption areas of the invention. The electric vehicle charging energy management method combining multiple power consumption areas of the invention can be applied to an application field having a first power consumption area and a second power consumption area, such as the first power consumption area 110 and the second power consumption area 120 in FIG. 1 and is executed by the processor 136 of the cloud management server 130. The application field has a predetermined power consumption limit. In other words, a total power consumption of the first power consumption area and the second power consumption area must be lower than the predetermined power consumption limit. The cloud management server can be coupled to the power consumption detection device in the first power consumption area and all the electric vehicle charging equipment in the second power consumption area through a network, such as a wired network, a telecommunication network, and a wireless network, such as a Wi-Fi network.

First, in step S410, the power consumption situation of at least one electrical equipment in the first power consumption area is detected by a power consumption detection device, and in step S420, the power consumption situation corresponding to the first power consumption area is received from the power consumption detection device by a cloud management server via a network. In some embodiments, the power consumption detection device may have a detection circuit or other power detection software and hardware components for detecting the power consumption of a specific power of a specific electrical equipment, thus to generate power detection data comprising a power state. For example, the power consumption detection device can detect current power consumption of the specific electrical equipment in the first power consumption area, so as to obtain the power consumption status corresponding to the specific electrical equipment, and generate power consumption data including the power consumption situation of the corresponding specific electrical equipment. In other words, the cloud management server can obtain the power consumption of all electrical equipment in the first power consumption area through the power consumption detection device. Thereafter, in step S430, an available electrical energy is calculated according to the predetermined power consumption limit for the application field and the power consumption situation, and then in step S440, the charging efficiency of each electric vehicle charging equipment in the second power consumption area is determined according to the available electrical energy. How to determine the charging efficiency of each electric vehicle charging equipment in the second power consumption area according to the available electrical energy will be described further in the following paragraphs. Next, in step S450, respective charging efficiency is then transmitted to each electric vehicle charging equipment in the second power consumption area via the network, wherein upon receiving respective charging efficiency from the cloud management server, each electric vehicle charging equipment charges at least one electric vehicle according to the respective charging efficiency received from the cloud management server.

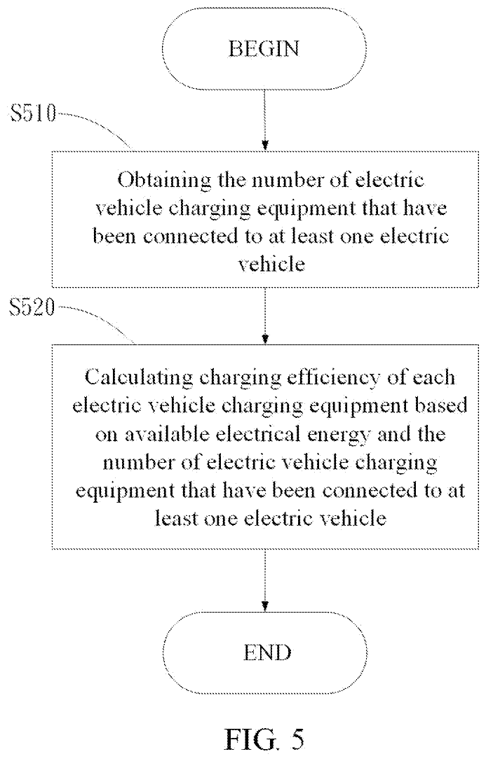

FIG. 5 is a flowchart of an embodiment of a method for determining the charging efficiency of the electric vehicle charging equipment of the invention.

First, in step S510, the cloud management server obtains the number of electric vehicle charging equipment that have been connected to the at least one electric vehicle. In this step, the cloud management server may determine whether each electric vehicle charging device is connected to at least one electric vehicle and obtain the number of electric vehicle charging equipment that have been connected to at least one electric vehicle accordingly. Then, in step S520, the charging efficiency of each of the electric vehicle charging equipment is calculated based on the available electrical energy and the number of electric vehicle charging equipment that have been connected to the at least one electric vehicle. It should be noted that each electric vehicle charging equipment may output power to charge the connected electric vehicle according to the corresponding independent charging efficiency. In other words, the cloud management server may monitor the number of electric vehicle charging equipment that have been connected to at least one electric vehicle in real time, and dynamically adjust the independent charging efficiency of each electric vehicle charging equipment accordingly. For example, in one embodiment, when the number of electric vehicle charging equipment that have been connected to at least one electric vehicle increases, the independent charging efficiency of the corresponding electric vehicle charging equipment becomes smaller, but the invention is not limited thereto. In some embodiments, when the cloud management server detects that the number of electric vehicle charging equipment that have been connected to the at least one electric vehicle has changed to a new number, it further recalculates the charging efficiency of each electric vehicle charging equipment according to the available electrical energy and the new number of electric vehicle charging equipment that have been connected to the at least one electric vehicle detected. Thereafter, the cloud management server transmits the calculated charging efficiency of each electric vehicle charging equipment to respective electric vehicle charging equipment in the second power consumption area via the network such that each electric vehicle charging equipment charges the electric vehicle connected thereto according to the respective charging efficiency received from the cloud management server.

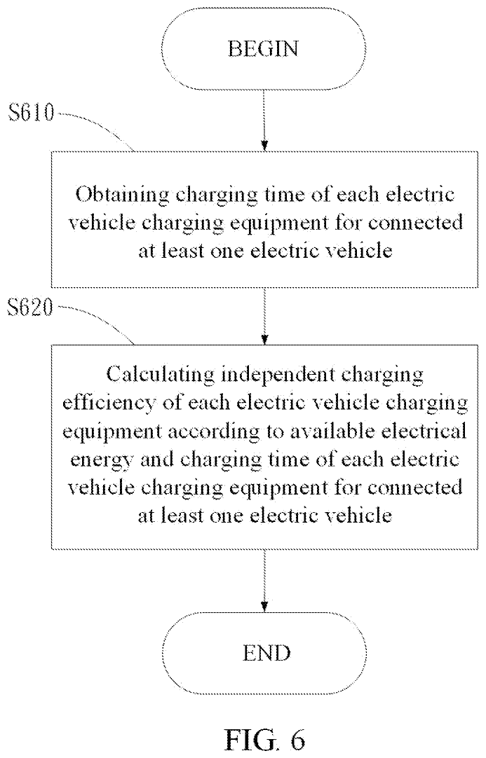

FIG. 6 is a flowchart of another embodiment of the method for determining the charging efficiency of the electric vehicle charging equipment of the invention.

First, in step S610, the cloud management server obtains a charging time of each electric vehicle charging equipment for the connected at least one electric vehicle. Then, in step S620, an independent charging efficiency of each electric vehicle charging equipment is calculated according to the available electrical energy and the charging time of each electric vehicle charging equipment for the connected at least one electric vehicle. It should be noted that each electric vehicle charging equipment may output power to charge the connected electric vehicle according to the corresponding independent charging efficiency. In other words, the cloud management server may monitor the charging time of each electric vehicle charging equipment for the connected at least one electric vehicle in real time, and dynamically adjust the independent charging efficiency of each electric vehicle charging equipment accordingly. For example, in one embodiment, when the charging time of electric vehicle charging equipment for the connected at least one electric vehicle becomes longer, the independent charging efficiency of the corresponding electric vehicle charging equipment becomes smaller, but the invention is not limited thereto. Thereafter, the cloud management server transmits the calculated charging efficiency of each electric vehicle charging equipment to respective electric vehicle charging equipment in the second power consumption area via the network such that each electric vehicle charging equipment charges the electric vehicle connected thereto according to the respective charging efficiency received from the cloud management server.

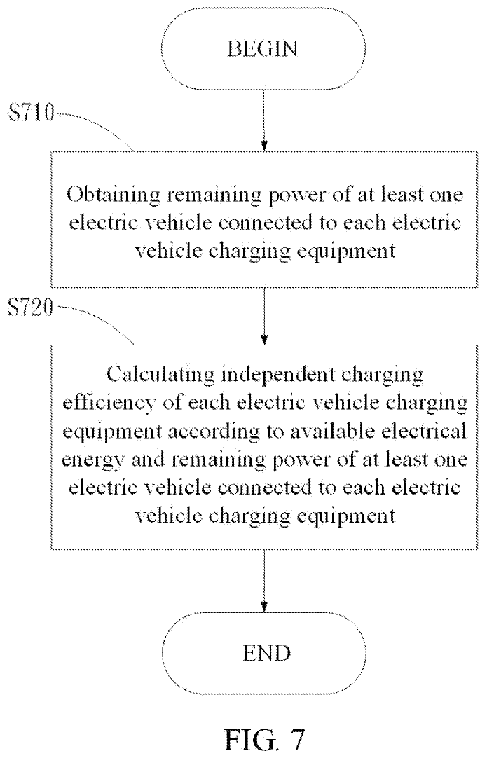

FIG. 7 is a flowchart of another embodiment of the method for determining the charging efficiency of the electric vehicle charging equipment of the invention.

First, in step S710, the cloud management server obtains a remaining power of the at least one electric vehicle connected to each electric vehicle charging equipment. In some embodiments, the remaining power of the at least one electric vehicle connected to each electric vehicle charging equipment may be transmitted to each electric vehicle charging equipment through respective at least one electric vehicle, and transmitted to the cloud management server through each electric vehicle charging equipment. In some embodiments, the remaining power of the at least one electric vehicle connected to each electric vehicle charging device may be directly transmitted to the cloud management server through respective at least one electric vehicle. Then, in step S720, an independent charging efficiency of each electric vehicle charging equipment is calculated according to the available electrical energy and the remaining power of the at least one electric vehicle connected to each electric vehicle charging equipment. It should be noted that each electric vehicle charging equipment may output power to charge the connected electric vehicle according to the corresponding independent charging efficiency. In other words, the cloud management server may monitor the remaining power of the at least one electric vehicle connected to each electric vehicle charging device in real time, and dynamically adjust the independent charging efficiency of each electric vehicle charging equipment accordingly. For example, in one embodiment, the more the remaining power of the electric vehicle, the smaller the independent charging efficiency of the corresponding electric vehicle charging equipment, but the invention is not limited thereto. Thereafter, the cloud management server transmits the calculated charging efficiency of each electric vehicle charging equipment to respective electric vehicle charging equipment in the second power consumption area via the network such that each electric vehicle charging equipment charges the electric vehicle connected thereto according to the respective charging efficiency received from the cloud management server.

In some embodiments, the cloud management server can transmit a charging state of the corresponding at least one electric vehicle to a smart phone through a network, wherein the owner of the corresponding at least one electric vehicle uses the smart phone to start the corresponding charging operation. It is noted that the cloud management server may periodically receive power consumption information transmitted by the electric vehicle charging equipment through the network during the period when the electric vehicle charging equipment is outputting power to charge the electric vehicle (i.e., during the charging process of the electric vehicle). Specifically, the electric vehicle charging equipment may regularly detect and report the power consumption information of the electric vehicle to the cloud management server during the charging process of the electric vehicle. In another embodiment, the cloud management server may regularly send a request to the electric vehicle charging equipment to detect and report the charging status of the electric vehicle during the charging process of the electric vehicle, so as to obtain the power consumption information of the electric vehicle. In one embodiment, the power consumption information of the electric vehicle at least includes information regarding charging status, such as a charging time, a charging progress and so on. Thereafter, the cloud management server may provide the user of the electric vehicle with information about the charging progress of the electric vehicle according to the power consumption information of the electric vehicle charging equipment. In some embodiments, when each electric vehicle charging equipment stops outputting power to the at least one electric vehicle, the cloud management server can transmit a specific information to the smart phone through the network, wherein the specific information is used to notify the owner that the electric vehicle has stopped charging.

For example, in one embodiment, the first power consumption area is a residential or household power consumption area, the second power consumption area is an area of household or home chargers, and the household electrical equipment shares power with the household or home chargers. It is assumed that the upper limit of total power consumption is 80 amps (A). The cloud management server can determine the power consumption of household electrical equipment (such as hair dryer, washing machine, TV, oven, etc.) in the first power consumption area through the return data of the power consumption detection device set in the household total electricity meter. When the power supply is enough, the household or home chargers can output power with the maximum output power for charging. When the power consumption of household electrical equipment is increased or becomes tight, the output power of the household or home chargers will be automatically decreased so that the total power consumption does not exceed the upper limit of the total power consumption, which can effectively prevent power tripping. It is understood that the above application field is only an example of the invention, and the invention is not limited thereto. Any application field having a plurality of power consumption areas with predetermined power consumption restrictions, including electric vehicle charging equipment, etc., can also be applied to the invention.

Therefore, the electric vehicle charging energy management systems and methods combining multiple power consumption areas of the present invention can detect the power consumption situation of all electrical equipment in the plurality of power consumption areas in the application field in real time, determine the available electrical energy based on the power consumption situation and the predetermined power consumption limit, and dynamically adjust the charging efficiency of each electric vehicle charging equipment according to the available electrical energy to perform the management of electric vehicle charging energy load, so as to effectively configure the power and reduce the pressure of power tripping, thereby providing users with a better experience and improving the practicability of charging services, thus reducing the cost of using electric vehicles and increasing the willingness to use the electric vehicles.

Electric vehicle charging energy management methods combining multiple power consumption areas, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for executing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for executing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalent.

What is claimed is:

1. An electric vehicle charging energy management system combining multiple power consumption areas applied to an application field having a predetermined power consumption limit, comprising:
a first power consumption area, comprising:
at least one electrical equipment; and
a power consumption detection device detecting the power consumption situation of at least one electrical equipment in the first power consumption area and transmitting the power consumption situation to a network;
a second power consumption area comprising a plurality of electric vehicle charging equipment for charging electric vehicles, wherein each electric vehicle charging equipment has a network connection unit, such that each electric vehicle charging equipment has a network connection capability; and
a cloud management server receiving the power consumption situation corresponding to the first power consumption area from the power consumption detection device via a network, calculating an available electrical energy according to the predetermined power consumption limit for the application field and the power consumption situation, determining a charging efficiency of each of the electric vehicle charging equipment in the second power consumption area according to the available electrical energy and transmitting respective charging efficiency to each electric vehicle charging equipment in the second power consumption area via the network,
wherein each electric vehicle charging equipment charges at least one electric vehicle according to the respective charging efficiency received from the cloud management server.

2. The system of claim 1, wherein the cloud management server further determines whether each of the electric vehicle charging equipment is connected to the at least one electric vehicle, and calculates the charging efficiency of each of the electric vehicle charging equipment based on the available electrical energy and the number of electric vehicle charging equipment that have been connected to the at least one electric vehicle.

3. The system of claim 2, wherein when the cloud management server detects that the number of electric vehicle charging equipment that have been connected to the at least one electric vehicle has changed to a new number, the cloud management server further recalculates the charging efficiency of each electric vehicle charging equipment according to the available electrical energy and the new number of electric vehicle charging equipment that have been connected to the at least one electric vehicle.

4. The system of claim 1, wherein the cloud management server further obtains a charging time of each electric vehicle charging equipment for the connected at least one electric vehicle, and calculates an independent charging efficiency of each electric vehicle charging equipment according to the available electrical energy and the charging time of each electric vehicle charging equipment for the connected at least one electric vehicle, wherein each of the electric vehicle charging equipment charges the connected electric vehicle according to the respective independent charging efficiency.

5. The system of claim 1, wherein the cloud management server further obtains a remaining power of the at least one electric vehicle connected to each electric vehicle charging equipment, and calculates an independent charging efficiency of each electric vehicle charging equipment according to the available electrical energy and the remaining power of the at least one electric vehicle connected to each electric vehicle charging equipment, wherein each of the electric vehicle charging equipment charges the connected electric vehicle according to the respective independent charging efficiency.

6. The system of claim 5, wherein the remaining power of the at least one electric vehicle connected to each electric vehicle charging equipment is transmitted to each electric vehicle charging equipment through the at least one electric vehicle, and transmitted to the cloud management server through each electric vehicle charging equipment.

7. The system of claim 5, wherein the remaining power of the at least one electric vehicle connected to each electric vehicle charging equipment is directly transmitted to the cloud management server through the at least one electric vehicle.

8. The system of claim 1, wherein the cloud management server transmits a charging status of the at least one electric vehicle to a smart phone via a network, and the owner of the at least one electric vehicle uses the smart phone to activate a corresponding charging operation.

9. The system of claim 8, wherein the cloud management server further transmits a specific information to the smart phone via the network when each of the electric vehicle charging equipment stops outputting, power to the at least one electric vehicle, wherein the specific information is used to notify the owner that the electric vehicle has stopped charging.

10. An electric vehicle charging energy management method combining multiple power consumption areas applied to an application field having a first power consumption area and a second power consumption area and having a predetermined power consumption limit, comprising:
detecting, by a power consumption detection device, the power consumption situation of at least one electrical equipment in the first power consumption area;
receiving, by a cloud management server, the power consumption situation corresponding to the first power consumption area from the power consumption detection device via a network;
calculating an available electric energy according to the predetermined power consumption limit for the application field and the power consumption situation;
determining a charging efficiency of each of a plurality of electric vehicle charging equipment in the second power consumption area according to the available electric energy; and
transmitting respective charging efficiency to each electric vehicle charging equipment in the second power consumption area via the network,
wherein each electric vehicle charging equipment charges at least one electric vehicle according to the respective charging efficiency received from the cloud management server.
